(19) United States
(12) Patent Application Publication
(10) Pub. No.: US 2005/0027647 A1
(43) Pub. Date: Feb. 3, 2005

(54) Method for prepayment of mortgage held at below market interest rate

(76) Inventor: Mikhail Bershteyn, Cupertino, CA (US)

Correspondence Address: Mikhail Bershteyn, 10820 Ashbourne Court, Cupertino, CA, 95014, US

(21) Appl. No.: 10/629,098

(22) Filed: Jul. 29, 2003

(51) Int. Cl. G06F 17/60

(52) U.S. Cl. 705/38

(57) ABSTRACT

A method for prepayment of mortgage having an associated fixed interest rate where the payoff amount is lowered in proportion with the difference between said fixed interest rate and the market interest rate for similar new mortgages. A method for prepayment of mortgage having an associated fixed interest rate or an adjustable interest rate and an associated rate adjustment schedule where the payoff amount is lowered in proportion with the difference between the principal amount of debt and the price that such mortgage would fetch if sold in the secondary market. Methods are used to offer borrowers mortgage prepayment incentive in an economic environment characterized by increasing interest rates.

### BACKGROUND OF THE INVENTION

The present invention generally relates to mortgages, and more particularly to residential and commercial mortgages.

Mortgages that are conventionally available allow the interest rates paid by the borrowers fluctuate only within the constraints set forth by mortgage agreements. Some mortgage loans set a fixed interest rate for the whole life of the loan (usually, 10, 15, or 30 years). These are commonly called fixed rate mortgages. Other types of mortgages allow interest rates to change within pre-agreed limits. Those are commonly referred to as adjustable rate mortgages. For any type of mortgage, the interest rates offered to the new applicants for a mortgage may (and usually do indeed) differ from the interest rates paid by the borrowers who had entered into mortgage agreements in the past.

In an environment where the interest rates on mortgage loans generally trend down over time, the borrowers can take advantage of the process commonly called mortgage refinancing. In essence, such borrowers are acting as issuers of debt securities that are paying interest substantially higher than do similar securities being issued at present. To the extent that their debt obligations are callable (absent prepayment restrictions) these debtors call them (prepay their loans) while at the same time issuing new obligations under the advantageous conditions.

Whenever the interest rates trend higher, the borrowers are put into a position that discourages any otherwise advantageous financial transactions that would involve paying off their mortgage loans. For example, someone with reduced need for a large house may be interested in lowering his or her debt by selling the house and buying a cheaper one. However, since current mortgage will be paid off and a new one taken at a higher interest rate, the reduction in loan principal amount will be offset by the increase in interest payment. Resulting monthly mortgage payment may therefore stay the same or even go up. In view of such circumstances, the individual in question may decline the financial opportunities resulting from him holding the assets he or she does not really need. Thus a portion of productive commercial activity becomes unnecessarily depressed. The result is the inefficient asset allocation, loss of jobs in the financial and construction sectors, etc.

Accordingly, it is the object of the present invention to provide a method for prepayment of mortgages held at below market interest rates in the economic environment where the interest rates go up, which remains attractive for the borrowers interested in such prepayment.

### BRIEF SUMMARY OF THE INVENTION

A method for prepayment of mortgage having an associated fixed interest rate where the payoff amount is lowered in proportion with the difference between said fixed interest rate and the market interest rate for similar new mortgages. A method where the borrower is allowed to prepay the principal amount of debt, in full or in part, directly to the lender that holds the mortgage obligation, and at a discount dependent on the difference between the fixed interest rate associated with the mortgage and market interest rate. A method where the third party acquires a mortgage loan from the current lender at a price prevailing in the secondary market for such loans, and then allows the borrower to prepay, in part or in full, principal amount of loan at a discount. A method where the third party acquires the portfolio of mortgage loans which display a statistically meaningful tendency of borrowers to prepay their loans, and then seeks out those borrowers willing to prepay, in part or in full, principal amount of loan at a discount.

A method for prepayment of mortgage having an associated fixed interest rate or an associated adjustable interest rate and an adjustment schedule where the payoff amount is lowered dependently on the difference between the principal amount of debt and the price that such mortgage would fetch if sold in the secondary market. A method where the borrower is allowed to prepay the principal amount of debt, in full or in part, directly to the lender that holds the mortgage obligation, and at a discount dependent on the difference between the principal amount of debt and the price that such mortgage would fetch if sold in the secondary market. A method where the third party acquires a mortgage loan from the current lender at the price prevailing in the secondary market for such loans, and then allows the borrower to prepay, in part or in full, principal amount of loan at a discount. A method where the third party acquires the portfolio of mortgage loans which display a statistically meaningful tendency of borrowers to prepay their loans, and then seeks out those borrowers willing to prepay, in part or in full, principal amount of loan at a discount.

The methods described will be used by the mortgage lenders and other financial institutions in an economic environment where the interest rates have risen significantly since large number of borrowers had entered into mortgage agreements. Such method will provide an incentive for borrowers to pay off their loans in part or in full even if the interest rate currently prevailing is higher than the one associated with their loans.

### BRIEF DESCRIPTION OF THE DRAWINGS

Features and advantages of this invention will become more apparent from the following detailed description in conjunction with the diagrams, which are shown here by way of example only.

FIG. 1 illustrates the dynamics of the difference between fixed interest rate associated with the mortgage and the market interest rate in the economic environment where the interest rates increase.

FIG. 2 illustrates the changing cost of a unit of loan issued at fixed interest rate in the economic environment where the interest rates increase.

FIG. 3 illustrates an embodiment of a method according to the present invention in application to fixed rate loans.

FIG. 4 illustrates an embodiment of a method according to the present invention in application to fixed rate loans or to adjustable rate loans.

### DETAILED DESCRIPTION OF THE INVENTION

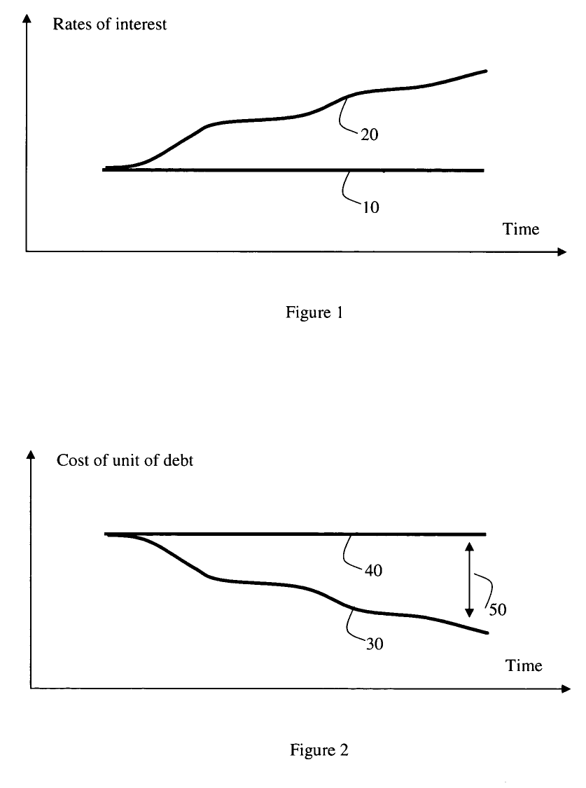

A method of mortgage prepayment according to the present invention allows the borrower who has a desire and an ability to prepay all or part of his mortgage to enjoy the advantages offered by the changing market conditions. Referring to FIG. 1, therein is illustrated a growing difference between the fixed value 10 of the interest rate associated with the mortgage loan, and the changing value 20 of the prevailing interest rates in the market, such as may occur in the economic environment where interest rates trend upwards.

Referring now to FIG. 2, therein is illustrated the corresponding change in the cost of the unit of debt secured by the mortgage 30 as compared to the fixed value of such unit of debt issued at the current level of interest rates at any given moment 40, which essentially represents the face value of the debt obligation. As it is well known from the economic theory and the practice of financial markets, the cost of the unit of dept (such as for example the price of a bond of a given face value) trends in the direction opposite to that of the interest rates. Over time, the difference 50 between the market cost of the unit of loan issued at a fixed interest rate on one hand, and its face value on another, can grow to a substantial amount. This phenomenon is well understood by the institutions buying and selling mortgage loans on the secondary market. For example, such major buyers of mortgage loans as Fanny Mae regularly publish the tables of the required interest rates for different kinds of loans which the corporation is offering to buy. Naturally, the price paid for the unit of loan is in direct proportion to the interest rate of such loan: the secondary buyer is prepared to pay a higher price for a mortgage that pays higher interest, and the lower price for a mortgage which is locked into a lower fixed interest rate that was prevalent in the past.

The difference 50 between the unit cost of the borrower's own loan obligation and the unit cost of similar loan presently issued at the market rate represents the value locked into the existing mortgage agreement. The inability of the borrower to take advantage of this value, absent the benefits of the present invention, leads such borrower to inefficient and disadvantageous asset allocation decisions. For example, a risk-averse borrower who has $100,000 available for investment and a mortgage with the outstanding balance of $300,000 may consider paying the available assets against his mortgage balance to represent the allocation option best reflecting his objectives and investment philosophy. However, upon realization that the interest rate of his mortgage loan is much lower than the interest rate currently offered in the market, the borrower may make another allocation of his assets, for example—put them into a money market account. He will thus not be able to take full advantage of the available assets. On the other hand, the lender too has his funds tied up in a mortgage that offers a rate of return lower than the one that can be obtained from investing the money under the market conditions that currently exist. The present invention serves thus to the advantage of both the borrower and the lender.

The main idea of the present invention is to allow the difference 50 between the unit cost of the borrower's own loan obligation and the unit cost of similar loan presently issued at the market rate, to be split between the borrower and the lender to the advantage of both sides. For example, an aforementioned borrower who is looking to allocate $100,000 could be allowed to reduce the balance of his mortgage by $110,000. At the same time, the lender could re-invest the same $100,000 in the current market to realize the income equal to the interest paid by the same borrower on the outstanding balance of $120,000. Both sides can thus use the present invention to their financial advantage. The relative gain that the borrower and the lender can claim to their own advantage is to be determined by free market forces of supply and demand. The initial determination of conditions for mortgage prepayment could also be assisted by the use of suitable economic models.

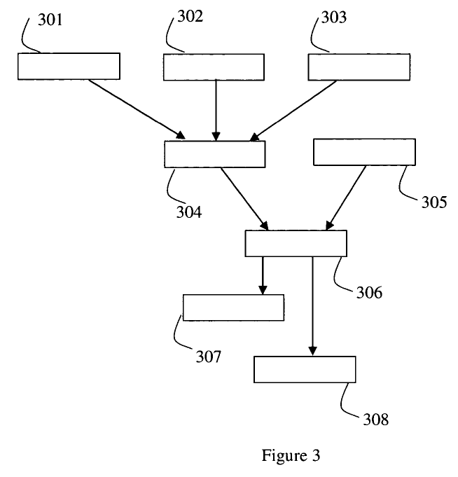

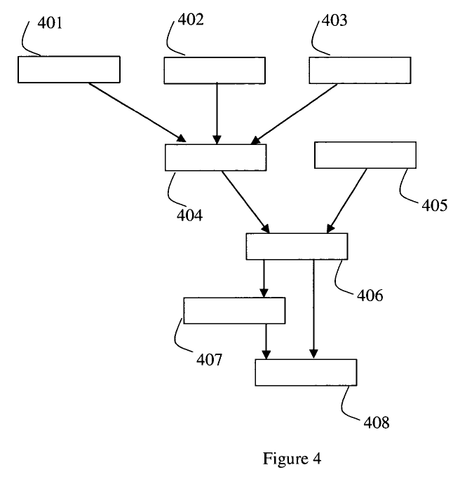

A preferred embodiment of the present invention as it applies to the fixed interest rate loans is shown, by way of example, in FIG. 3.

In one preferred embodiment of the present invention, the mortgage lender performs the search 301 of his own mortgage portfolio to identify an account with associated fixed interest rate 304 that is below current market interest rate 305. Said lender performs the computation 306 of the amount that he is willing to accept from the borrower in order to reduce the outstanding mortgage balance of the borrower by one dollar. As this amount is less than one, such offer creates a suitable incentive for a borrower to allocate funds to mortgage prepayment rather than to other investments. As this amount is also higher than the amount of money invested in a similar mortgage in the current market conditions that will produce the same return as one dollar does in the mortgage being prepaid, the lender also stands to gain from the prepayment of a loan and reinvestment of the proceeds. This way, an offer to prepay 308 that the lender presents the identified borrower is advantageous for both sides. In a preferred embodiment of the present invention, the computation step 306 takes into account factors such as the remaining term of the loan, the estimated level of the risk of default, etc. generally through the use of the appropriate model.

Thus in this preferred embodiment of the present invention the mortgage prepayment is taking place through direct transaction between the borrower and the lender.

In another embodiment of the present invention, an interested third party conducts the search 302 of the borrower who holds the mortgage with associated interest rate 304 below market interest rate 305, and who is willing to prepay the mortgage in full or in part. Upon finding such borrower, and performing computation 306 of the amount this third party is prepared to accept from said borrower in satisfaction of $1 of the principal, said third party performs acquisition 307 of the loan from the current lender for a price which is lower, per $1 of the principal balance, than the amount it will accept from the borrower. The difference between the amount of prepayment and the price paid for acquisition of the loan represents the profit of the said third party.

In yet another embodiment of the present invention, a financial institution may acquire a portfolio 303 of the mortgage loans that as a whole meet certain statistical criterion as being likely subjects for prepayment. Such institution then proceeds with an offer 308 to each of the borrowers whose loans are included in said portfolio to prepay their outstanding balances in whole or in part at a discount relative to the face value of such balances, as determined through step 306.

A preferred embodiment of the present invention as it applies to either the fixed interest rate loans or to the adjustable interest rate loans is shown, by way of example, in FIG. 4.

In one preferred embodiment of the present invention, the mortgage lender performs the search 401 of his own mortgage portfolio to identify an account which, if sold in the secondary market, would fetch a price 404 that is substantially below current outstanding loan balance 405. Said lender performs the computation 406 of the amount that he is willing to accept from the borrower in order to reduce the outstanding mortgage balance of the borrower by one dollar. As this amount is less than one, such offer creates a suitable incentive for a borrower to allocate funds to mortgage prepayment rather than to other investments. As this amount is also higher than the amount of money invested in a similar mortgage in the current market conditions that will produce the same return as one dollar does in the mortgage being prepaid, the lender also stands to gain from the prepayment of a loan and reinvestment of the proceeds. This way, an offer to prepay 408 that the lender presents the identified borrower is advantageous for both sides. In a preferred embodiment of the present invention, the computation step 406 takes into account factors such as the remaining term of the loan, the estimated level of the risk of default, etc. generally through the use of the appropriate model.

Thus in this preferred embodiment of the present invention the mortgage prepayment is taking place through direct transaction between the borrower and the lender.

In another embodiment of the present invention, an interested third party conducts the search 402 of the borrower who holds the mortgage that would fetch a price 404 in the secondary that is substantially below current outstanding loan balance 405, and who is willing to prepay the mortgage in full or in part. Upon finding such borrower, and performing computation 406 of the amount this third party is prepared to accept from said borrower in satisfaction of $1 of the principal, said third party performs acquisition 407 of the loan from the current lender for a price which is lower, per $1 of the principal balance, than the amount it will accept from the borrower. The difference between the amount of prepayment and the price paid for acquisition of the loan represents the profit of the said third party.

In yet another embodiment of the present invention, a financial institution may acquire a portfolio 403 of the mortgage loans that as a whole meet certain statistical criterion as being likely subjects for prepayment. Such institution then proceeds with an offer 408 to each of the borrowers whose loans are included in said portfolio to prepay their outstanding balances in whole or in part at a discount relative to the face value of such balances, as determined through step 406.

Although the invention has been described in its preferred forms with a certain degree of particularity, it is understood that the present description has been made only by way of example. Numerous changes in the details of the implementation may be made by those skilled in the art without departing from the spirit and scope of the invention as herein claimed. It is intended that the patent shall cover by suitable expression in the appended claims, whatever features of patentable novelty exist in the invention disclosed.

1. A method for prepayment of mortgage having an associated fixed interest rate, such method comprising the step of comparing said fixed interest rate with a time-varying market interest rate, and the step of computing an acceptable amount of loan payoff dependently on the difference between said market interest rate and said fixed interest rate, whereby a payoff amount is smaller than the principal balance of the loan, the difference between loan balance and payoff amount comprising a loan discount that is offered to the borrower.

2. A method of claim 1 where the borrower prepays full or partial principal amount of debt at a discount, directly to the lender that holds the mortgage obligation.

3. A method of claim 1 where the third party acquires a mortgage loan from the current lender at the price prevailing in the secondary market for such loans, and then offers the borrower to prepay, in part or in full, principal amount of loan at a discount.

4. A method of claim 1 where the third party acquires the portfolio of mortgage loans which display a statistically meaningful tendency of borrowers to prepay their loans, and then seeks out those borrowers willing to prepay, in part or in full, principal amount of loan at a discount.

5. A method for prepayment of mortgage having an associated fixed interest rate or an associated adjustable interest rate and a rate adjustment schedule such method comprising the step of comparing the outstanding balance of the loan with the time-varying value that the loan obligation would fetch in the secondary market, and the step of computing an acceptable amount of loan payoff dependently on the difference between said principal balance and said price, whereby a payoff amount is smaller than the principal balance of the loan, the difference between loan balance and payoff amount comprising a loan discount that is offered to the borrower.

6. A method of claim 5 where the borrower prepays the principal amount of debt, in full or in part, directly to the lender that holds the mortgage obligation.

7. A method of claim 5 where the third party acquires a mortgage loan from the current lender at the price prevailing in the secondary market for such loans, and then offers the borrower to prepay, in part or in full, principal amount of loan at a discount.

8. A method of claim 5 where the third party acquires the portfolio of mortgage loans which display a statistically meaningful tendency of borrowers to prepay their loans, and then seeks out those borrowers willing to prepay, in part or in full, principal amount of loan at a discount.
